(19) United States
(12) Patent Application Publication
(10) Pub. No.: US 2025/0174812 A1
(43) Pub. Date: May 29, 2025

(54) Battery Module and Battery Pack Including the Same

(71) Applicant: SK On Co., Ltd., Seoul (KR)

(72) Inventors: Seo Roh RHEE, Daejeon (KR); Seung Dong LEE, Daejeon (KR); Dong Jin KIM, Daejeon (KR); Hyun Kyu LEE, Daejeon (KR)

(21) Appl. No.: 18/944,210

(22) Filed: Nov. 12, 2024

(30) Foreign Application Priority Data
Nov. 24, 2023 (KR) 10-2023-0165389

(51) Int. Cl. H01M 50/342; H01M 50/105; H01M 50/178; H01M 50/186; H01M 50/211; H01M 50/271; H01M 50/383; H01M 50/503

(52) U.S. Cl. CPC H01M 50/3425; H01M 50/105; H01M 50/178; H01M 50/186; H01M 50/211; H01M 50/271; H01M 50/383; H01M 50/503

(57) ABSTRACT

A battery module includes a cell assembly including a plurality of battery cells, each battery cell including a body portion, a flange portion, and an electrode lead exposed in a first direction to the outside of the flange portion, a busbar coupled to the electrode lead, and a support plate disposed between the battery cell and the busbar and including a through-hole through which the electrode lead passes in the first direction, wherein the flange portion includes a sealing region, the through-portion includes a first region disposed closer to the busbar than the body portion and a second region disposed closer to the body portion than the busbar, and the first region is configured to cover 60% or more of a sealing length, which is a length of the sealing region, based on the first direction.

### CROSS-REFERENCE TO RELATED APPLICATION(S)

This patent document claims the priority and benefits of Korean Patent Application No. 10-2023-0165389 filed in the Korean Intellectual Property Office on Nov. 24, 2023, the disclosure of which is incorporated herein by reference in its entirety.

### TECHNICAL FIELD

The disclosure and implementations disclosed in this patent document generally relate to a battery module including a plurality of secondary battery cells that may be charged and discharged, and a battery pack including the same.

### BACKGROUND

As the development of technology and demand for mobile devices, electric vehicles, energy storage devices, etc. have increased, demand for secondary battery cells as an energy source has rapidly increased. Secondary battery cells are batteries in which mutual conversion between chemical energy and electrical energy is reversible, and thus, secondary battery cells may be repeatedly charged and discharged.

A battery cell includes an electrode assembly including a cathode, an anode, a separator, and an electrolyte, the main components of a secondary battery. A battery cell may be configured as a pouch-type battery cell, a prismatic or a cylindrical can-type battery cell.

A plurality of battery cells may be stacked to form a battery module or a battery pack and may be used for various purposes, such as electric vehicles and energy storage systems (ESS).

### SUMMARY

An electrode assembly generates heat during a charging and discharging process, and a temperature rise due to the heating may deteriorate the performance of a battery cell.

In addition, in some battery cells, gas may occur therein due to internal factors of the battery device (including a battery module and a battery pack), such as the temperature rise of the battery cells. For example, the amount of gas occurring in the battery cells may increase in a vulnerable environment, such as a high temperature.

In the case of a pouch-type battery cell, if gas occurs inside a film casing, a sealed portion (a welded portion) may swell and rupture. If the sealed portion swells and ruptures, a venting phenomenon may occur in which gas inside the battery cell is discharged externally. If a venting timing due to the rupturing of the sealed portion comes earlier, the electrolyte inside the battery cell may evaporate, and the capacity of the battery cell may decrease rapidly, accordingly. As a result, the lifespan of the battery module or battery pack may be significantly reduced.

According to an aspect of the present disclosure, a battery module in which a venting timing may be delayed and a battery pack including the same may be provided.

According to another aspect of the present disclosure, a battery module in which a location at which venting occurs in a battery cell may be controlled and a battery pack including the same may be provided.

The battery module of the present disclosure and the battery pack including the same according to the present disclosure may be widely applied in green technology fields, such as electric vehicles, battery charging stations, and solar power generation and wind power generation using batteries. In addition, the battery module of the present disclosure and the battery pack including the same may be used in eco-friendly electric vehicles, hybrid vehicles, etc. to prevent a climate change by suppressing air pollution and greenhouse gas emissions.

In some embodiments of the present disclosure, a battery module includes: a cell assembly including a plurality of battery cells, each battery cell including a body portion accommodating an electrode assembly, a flange portion extending from at least a portion of a periphery of the body portion, and an electrode lead electrically connected to the electrode assembly and exposed in a first direction to the outside of the flange portion; a busbar coupled to the electrode lead of each battery cell; and a support plate disposed between the battery cell and the busbar and including a through-hole through which the electrode lead passes in the first direction, wherein the flange portion includes a sealing region in which an outer sheet that is folded is fused, the through-portion includes a first region disposed closer to the busbar than the body portion and a second region disposed closer to the body portion than the busbar and continuously connected to the first region, and the first region is configured to cover 60% or more of a sealing length, which is a length of the sealing region, based on the first direction.

The first region and the second region may be configured to intersect each other at a boundary between the first region and the second region.

The first region may be configured to have a preset constant interval, and the second region is configured to form a space (gap) becoming wider toward the body portion. A gap between the sealing region and the first region may be 2 mm or less.

The first region may be configured to have a smaller inclination angle than an inclination angel of the second region, based on (with respect to) the first direction.

The first region may be configured to have an inclination angle less than 3 degrees based on the first direction, and the second region is configured to have an inclination angle of 5 degrees or more based on the first direction.

Based on the first direction, the first region may be configured to cover 70% or more and 100% or less of the sealing length.

Based on the first direction, a second length, which is a length of the second region, may be 0.5 times or more of the sealing length.

The second length may be configured to have a value equal to or less than that of the sealing length.

Based on the first direction, a second length, which is a length of the second region, may be configured to have a value equal to or smaller than a first length, which is a length by which the first region covers the sealing region.

Based on the first direction, the sum of a first length, which is a length by which the first region covers the sealing region, and a second length, which is a length of the second region, may be configured to have a value less than or equal to twice the sealing length.

The busbar may include a coupling hole coupled to the electrode lead of each battery cell, and the electrode lead may be configured to pass through the through-portion in the first direction and then be inserted into the coupling hole.

The first region and the second region may be formed integrally in the support plate.

The through-portion of the support plate may include a plurality of through-portions so that a plurality of electrode leads are inserted in the first direction, while the plurality of battery cells are stacked.

The plurality of through-portions may be integrally formed in the support plate.

The flange portion may be disposed on at least three sides of a perimeter of the body portion, and the flange portion may include a first flange in which the electrode lead is disposed and a second flange in which the electrode lead is not disposed.

The battery module may further include: a module housing accommodating the cell assembly and including a housing cover covering a top surface of the cell assembly, wherein the housing cover faces the second flange.

The second flange may include a folded portion folded in a length direction of the battery cell and a tape covering the folded portion to restrict the folded portion from unfolding.

In some embodiments of the present disclosure, a battery module includes: a cell assembly including a plurality of battery cell each including a body portion accommodating an electrode assembly, a flange portion extending from at least a portion of a periphery of the body portion and including a sealing region, and an electrode lead exposed to the outside of the flange portion in a first direction; a busbar including a plurality of coupling holes coupled to the electrode leads of the plurality of battery cells; and a support plate disposed between the plurality of battery cells and the busbar, and including a plurality of through-portions through which the electrode leads of the plurality of battery cells pass in the first direction, wherein each through-portion includes a first region facing at least a portion of the sealing region and a second region continuously connected to the first region and extending toward the body portion, and the first region is configured to cover 60% or more of a sealing length, which is a length of the sealing region, based on the first direction.

In some embodiments of the present disclosure, a battery pack includes: a plurality of battery modules described above; and a pack frame accommodating the plurality of battery modules.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module according to an embodiment;

FIG. 2 is an exploded perspective view of the battery module illustrated in FIG. 1;

FIG. 3 is a perspective view of a battery cell according to an embodiment;

FIG. 4 is a cross-sectional view taken along line I-I′ of FIG. 3;

FIG. 5 is a cross-sectional view taken along a portion of line II-II′ of FIG. 2;

FIGS. 6A to 7C illustrate experimental results according to the first and second embodiments of the present disclosure, respectively, in which FIGS. 6A and 7A are cross-sectional views illustrating a state in which a flange portion and an electrode lead are disposed on a support plate, FIGS. 6B and 7B are graphs illustrating whether a battery cell is vented over time, and FIGS. 6C and 7C are schematic diagrams indicating a portion in which venting occurs;

FIGS. 8A to 9C illustrate experimental results according to a first comparative example and a second comparative example, respectively, in which FIGS. 8A and 9A are cross-sectional views illustrating a state in which a flange portion and an electrode lead are disposed on a support plate, FIGS. 8B and 9B are graphs illustrating whether a battery cell is vented over time, and FIGS. 8C and 9C are schematic diagrams indicating a portion in which venting occurs;

FIGS. 10A to 10C illustrate experimental results according to a modified example, in which FIG. 10A is a cross-sectional view illustrating a state in which a flange portion and an electrode lead are disposed on a support plate, FIG. 10B is a graph illustrating whether a battery cell is vented over time, and FIG. 10C is a schematic diagram indicating a portion in which venting occurs; and

FIG. 11 is an exploded perspective view of a battery pack according to an embodiment.

### DETAILED DESCRIPTION

The same reference numerals or symbols respectively illustrated in the attached drawings denote parts or elements that perform the actually same functions. For convenience of description and understanding, the parts or elements will be described by using the same reference numerals or symbols even in different embodiments. In other words, although elements having the same reference numerals are all illustrated in a plurality of drawings, the plurality of drawings do not refer to an embodiment.

As used herein, the singular forms are intended to include the plural forms as well, unless the context clearly indicates otherwise. It will be further understood that the terms “comprises,” “comprising,” etc. when used in this specification, specify the presence of stated features, integers, steps, operations, elements, and/or components, but do not preclude the presence or addition of one or more other features, integers, steps, operations, elements, components, and/or groups thereof.

In addition, in the present specification, the expressions, such as an upper side, a lower side, a side face, a rear surface, and the like, are described based on the drawings and may be expressed differently when the direction of the corresponding object is changed.

The terms including ordinal numbers, such as ‘first’, ‘second’, etc. may be used herein to distinguish elements from one another. These ordinal numbers are merely used to distinguish the same or similar elements from one another, and meanings of the terms are not construed as being limited by the using of the ordinal numbers. For example, use orders or arrangement orders of elements combined with these ordinal numbers are not limited by numbers thereof. The ordinal numbers may be redisposed with one another.

Hereinafter, the present disclosure will be described in detail with reference to the accompanying drawings. However, this is merely illustrative and the present disclosure is not limited to the specific embodiments described by way of example.

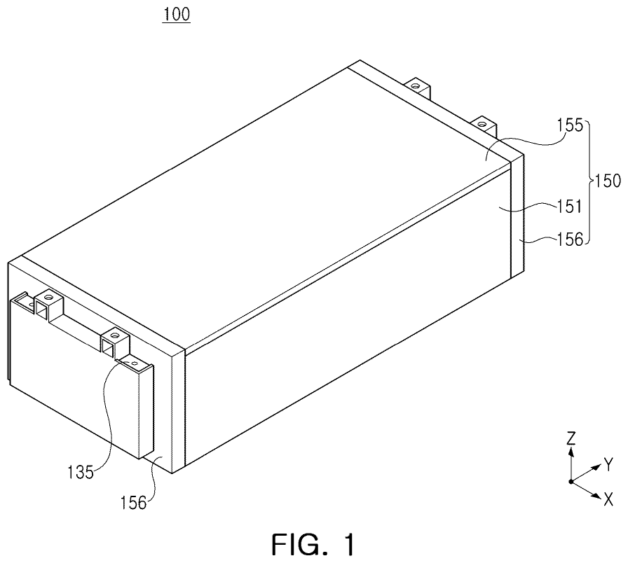

First, a battery module 100 according to an embodiment will be described with reference to FIGS. 1 to 5.

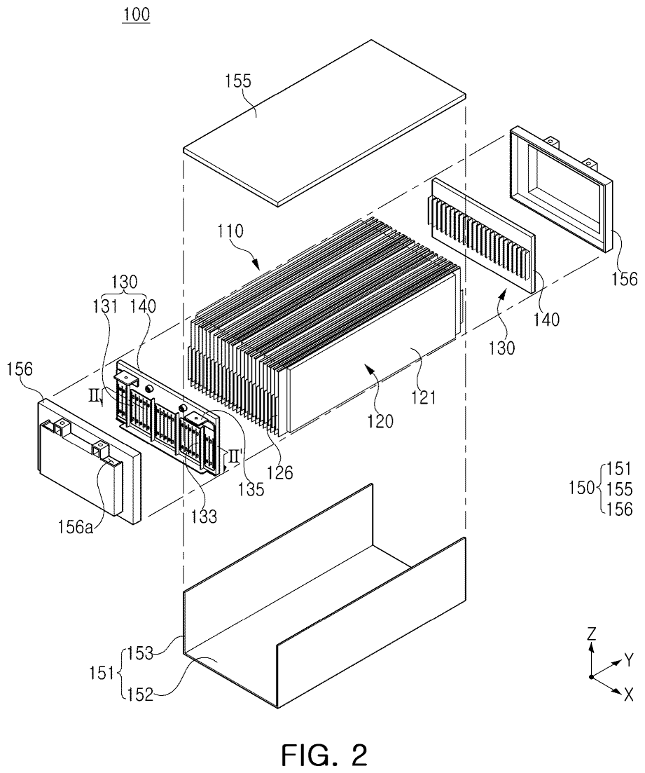

FIG. 1 is a perspective view of a battery module 100 according to an embodiment of the present disclosure, and FIG. 2 is an exploded perspective view of the battery module 100 illustrated in FIG. 1.

Referring to FIGS. 1 and 2, the battery module 100 according to an embodiment may include a cell assembly 110 including a plurality of battery cells 120 and a busbar assembly 130 including an electrically conductive busbar 131 and a support plate 140. The battery module 100 according to an embodiment may additionally include a module housing 150 accommodating the cell assembly 110.

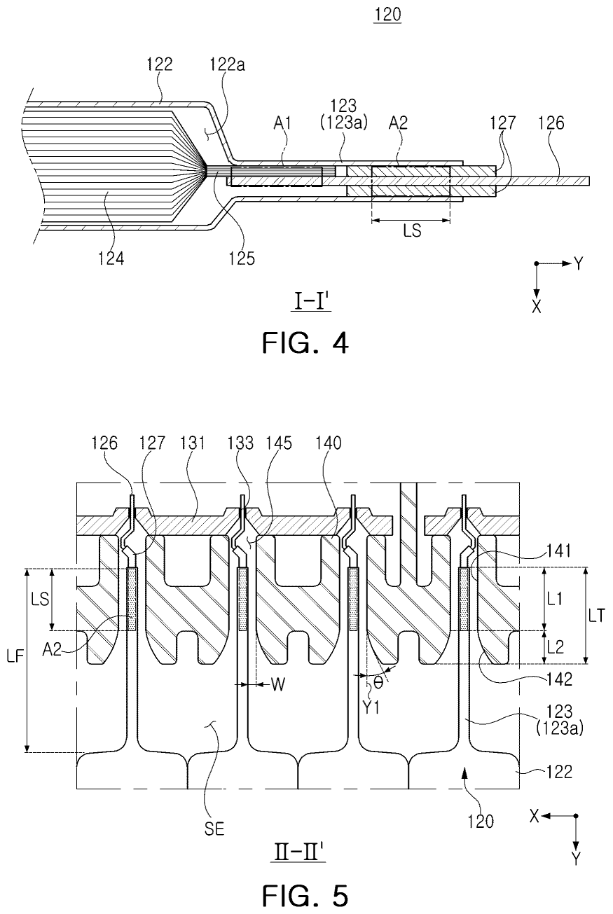

In the battery cell 120 of the present disclosure, a width direction (a length direction refers to a direction (a Y-axis) in which an electrode lead 126 extends from an electrode assembly (124 of FIG. 4), a thickness direction refers to a direction (an X-axis), perpendicular to a large surface of the electrode assembly, and a height direction (an up-down direction) refers to a direction (Z-axis), perpendicular to the width direction and the thickness direction. In addition, in the battery module 100 and the battery cell 120, a first direction may refer to the Y-axis direction, a second direction may refer to the X-axis direction, and a third direction may refer to the Z-axis direction.

The cell assembly 110 may have a shape in which a plurality of battery cells 120 are stacked. In an embodiment, the plurality of battery cells 120 may be stacked with their large surfaces facing each other. For example, the plurality of battery cells 120 may be arranged in the second direction X. However, it is also possible to configure the plurality of battery cells 120 to be stacked in the third direction Y as needed.

In order to maintain the shape of the cell assembly 110, neighboring battery cells 120 may be attached to each other by double-sided tape. The double-sided tape may be attached to a side (large surface) of the battery cell 120 to mutually fix the plurality of battery cells 120.

Each battery cell 120 may be configured as a pouch-type battery cell in which the electrode assembly (124 of FIG. 4) is accommodated in a pouch (outer casing) 121. Each battery cell 120 may include the electrode lead 126 exposed to the outside of the pouch 121. The electrode lead 126 may be electrically connected to the electrode assembly.

The busbar assembly 130 may include an electrically conductive busbar 131 electrically connected to the electrode lead 126 of the battery cell 120 and an electrically insulating support plate 140. The support plate 140 may be disposed (located) between the plurality of battery cells 120 and the electrically conductive busbar 131 to support the busbar 131. The busbar 131 may be hook-coupled to or fixed to the support plate 140 in a fused state.

The busbar assembly 130 may be located to face the electrode lead 126 of the battery cells 120 and coupled to the electrode lead 126. For example, when the electrode lead 126 is disposed at both ends of the battery cell 120 in the first direction Y, the busbar assembly 130 may be coupled to the electrode lead 126 at both ends of the battery cell 120 in the first direction Y.

The electrode lead 126 may be coupled to the busbar 131 on the outside of the busbar assembly 130 by penetrating through the support plate 140 of the busbar assembly 130. To this end, the support plate 140 may include a through-portion (145 in FIG. 5) through which the electrode lead 126 passes in the first direction Y, and the busbar 131 may include a coupling hole 133 through which the electrode lead 126 passes to be coupled. The electrode lead 126 may be welded to the busbar 131 while penetrating through the coupling hole 133. The plurality of battery cells 120 may be electrically connected in series and/or in parallel by a plurality of busbars 131.

The busbar assembly 130 may include a connection terminal 135 for external electrical connection with the busbar 131. The battery cell 120 may be electrically connected externally through the connection terminal 135. The connection terminal 135 may be exposed externally through a through-hole 156a formed in an end plate 156 as shown in FIG. 2. The through-hole 156a of the end plate 156 may be formed in a size corresponding to a size and shape of the connection terminal 135.

The module housing 150 forms the exterior of the battery module 100 and may accommodate the cell assembly 110 therein. That is, the module housing 150 is disposed outside the cell assembly 110 to protect the battery cell 120 from an external environment.

The module housing 150 may have various shapes or divided structures. As an example, the module housing 150 may include a housing body 151 having a cross-sectional shape with one side open and a housing cover 155 combined with the housing body 151 to form an internal space. The housing cover 155 may cover a top surface of the cell assembly 110.

The housing body 151 may include a lower plate 152 supporting a lower portion of the cell assembly 110 and a side plate 153 extending from both ends of the lower plate 152 in the up-down direction Z and supporting a side surface of the cell assembly 110. The housing body 151 may form a U-shaped cross-section with one side (upper side) open. The side plate 153 may support the side surface of the cell assembly 110 to correspond to the side surface (large surface) of the cell assembly 110 stacked in a left-right direction.

In addition, the module housing 150 may have a structure in which the end plate 156 is coupled to front and rear surfaces of the module housing 150 in the length direction to cover an internal space formed by the housing body 15 and the housing cover 155. The end plates 156 may be coupled to both side surfaces in which the electrode lead 126 of the battery cell 120 is disposed, that is, both sides of the module housing 150 in the first direction Y.

The cell assembly 110 may be disposed in the internal space of the module housing 150. At least one surface of the module housing 150 may function as a heat dissipation plate releasing heat generated by the battery cell 120 externally.

At least a portion of the module housing 150 may be formed of a material with high thermal conductivity, such as metal. For example, the module housing 150 may include aluminum. However, the material of the housing body 151 is not limited thereto, and various materials may be used as long as they have strength and thermal conductivity similar to metal, even if they are not metal.

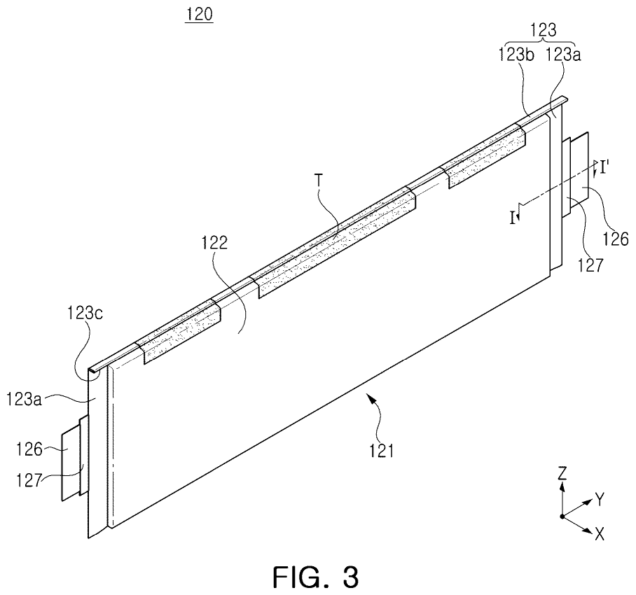

FIG. 3 is a perspective view of the battery cell 120 illustrated in FIG. 2, and FIG. 4 is a cross-sectional view taken along line I-I′ of FIG. 3.

Referring to FIGS. 3 and 4, the battery cell 120 may be configured as a pouch-type battery cell in which the electrode assembly 124 is accommodated inside a flexible pouch 121.

The battery cell 120 may include a body portion 122 accommodating an electrode assembly therein, a flange portion 123 extending from at least a portion of the perimeter of the body portion 122, and the electrode lead 126 electrically connected to the electrode assembly 124. The electrode lead 126 may be exposed from the electrode assembly 124 toward the outside of the flange portion 123. For example, the electrode lead 126 may be exposed in the first direction Y toward the outside of the flange portion 123.

The pouch 121 is formed in a container shape and provides an internal space 122a in which the electrode assembly 124 and an electrolyte are accommodated. For example, the pouch 121 may be formed of an outer sheet (pouch film) laminated with aluminum and a resin, such as polypropylene. However, the material constituting the pouch 121 may be variously changed.

The pouch 121 may be divided into a body portion 122 and a flange portion 123. The body portion 122 is formed to have a container shape and provides an internal space 122a having a certain shape in which an electrode assembly and an electrolyte are accommodated. For example, the body portion 122 may have a rectangular perimeter.

The flange portion 123 may extend from at least a portion of the perimeter of the body portion 122. The flange portion 123 may be formed in a flange shape in which at least a portion of the perimeter of the body portion 122 formed in a container shape extends outwardly. For example, the flange portion 123 may have a shape extending from three of the four sides of the body portion 122. The flange portion 122 may be disposed on at least three sides of a perimeter of the body portion 123. The flange portion 123 may have a state in which the outer sheets constituting the pouch 121 are folded or overlap each other. The flange portion 123 may include a portion in which the outer sheets overlapping each other are bonded to seal the body portion 122. A heat-fusion method may be used for bonding the flange portion 123, but is not limited thereto.

The electrode lead 126 may be exposed externally through a portion of the flange portion 123. The electrode lead 126 may include a positive electrode lead connected to a positive electrode plate and a negative electrode lead connected to a negative electrode plate. In an embodiment, the flange portion 123 may be divided into a first flange 123a in which the electrode lead 126 is disposed and a second flange 123b in which the electrode lead 126 is not disposed. In the first flange 123a, the electrode lead 126 may be covered by an insulating portion 127. The insulating portion 127 may increase electrical insulation between the electrode lead 126 and the pouch 121 and increase the sealing degree of a sealing region A2. The insulating portion 127 may include an insulating film.

In the case of the battery cell 120 illustrated in FIG. 3, electrode leads 126 are illustrated as being disposed on both sides of the body portion 122 based on (with respect to) the first direction Y of the battery cell 120. That is, FIG. 3 illustrates a configuration in which the positive electrode lead and the negative electrode lead are disposed to face in different directions. However, the positive electrode lead and the negative electrode lead may also be disposed to be spaced apart from each other to face in the same direction on one side of the body portion 122.

In an embodiment, in the battery cell 120, in order to increase the bonding reliability of the flange portion 123 and minimize an extended length of the flange portion 123, a portion of the flange parts 123 may be folded at least once. For example, in the flange portion 123, the second flange 123b of the flange portion 123 in which the electrode lead 126 is not disposed may include a folded portion 123c folded in the length direction Y of the battery cell 120. The folded portion 123c may have a structure folded by at least one folding process. The second flange 123b may include at least one tape T covering the folded portion 123c to restrict the folded portion 123c from unfolding. The tape T may wrap the folded portion 123c. The tape T may restrict the folded portion 123c from being unfolded to be deformed due to an increase in internal pressure of the battery cell 120.

Meanwhile, the pouch 121 may form the body portion 122 and the flange portion 123 using a single outer sheet. For example, after forming a storage space corresponding to the body portion 122 on the single outer sheet, an electrode assembly may be disposed in the storage space, and the outer sheet in which the storage space is formed may be folded to overlap each other to form the flange portion 123. In this case, the flange portion 123 may have a shape extending from three sides of the body portion 122 as shown in FIG. 3, and the flange portion 123 may seal three sides of the body portion 122. The battery cell 120 having this structure may have a three-sided sealing structure sealing three sides of the body portion 122.

Alternatively, the pouch 121 may include the body portion 122 and the flange portion 123 using two outer sheets. In this case, the flange portion 123 may extend from four sides of the body portion 122 and may seal the four sides of the body portion 122. The battery cell having this structure may have a four-side sealing structure sealing the four sides of the body portion 122.

Referring to FIG. 3 together with FIG. 2, the flange portion 123 may be disposed on three or more sides of the perimeter of the body portion 122. The flange portion 123 may include the first flange 123a on which the electrode lead 126 is disposed and the second flange 123b on which an electrode lead 126 is not disposed. The first flange 123a may be disposed to face the busbar assembly 130, and the second flange 123b may be disposed to face the housing cover 155. The housing cover 155 may face the second flange 123b.

Referring to FIG. 4, a cross-sectional shape of the portion of the battery cell 120 in which the electrode lead 126 is disposed will be described in more detail.

The electrode assembly 124 may include a plurality of electrode plates and a separator and may be accommodated in the internal space 122a of the body portion 122. The electrode plates may include a positive electrode plate and a negative electrode plate. The electrode assembly may be configured in a form in which the positive electrode plate and the negative electrode plate are stacked with the separator interposed therebetween in a state in which the large surfaces of the positive electrode plate and the negative electrode plate face each other. The plurality of positive electrode plates and the plurality of negative electrode plates may each include the electrode tab 125. The electrode tab 125 may be connected to the electrode lead 126 so that the same polarity contacts each other. For example, the positive electrode tab disposed on the positive electrode plate may be connected to the positive electrode lead, and the negative electrode tab disposed on the negative electrode plate may be connected to the negative electrode lead.

The electrode tabs 125 respectively extending from the plurality of electrode plates may be welded with the electrode lead 126. The electrode tabs 125 and the electrode leads 126 may be bonded by laser welding, ultrasonic welding, etc. in the welding region A1.

The flange portion 123 may include the sealing region A2 in which two folded outer sheets are fused. The sealing region A2 may be formed in the flange portion 123 to seal the perimeter of the body portion 122. The electrode lead 126 may be exposed to the outside of the battery cell 120 through the first flange 123a. Since the electrode lead 126 is disposed in the first flange 123a, the sealing region A2 of the first flange 123a may be bonded while the electrode lead 126 is disposed between the two outer sheets. The bonding between the two outer sheets and the electrode lead 126 may be performed using thermal fusion, but is not limited thereto.

In the first flange 123a, the electrode lead 126 may be covered by the insulating portion 127. In this case, the electrode lead 126 may be bonded to the outer sheet while being covered by the insulating portion 127. The sealing region A2 may have a preset length (width) based on the first direction Y, which is a direction in which the electrode lead 126 extends. The sealing region A2 may have a preset sealing length LS based on the first direction Y. In the present disclosure, the ‘sealing length LS’ is defined as a length (width) of the portion of the flange portion 123 in which bonding or thermal fusion is performed, and is distinguished from the entire length of the flange portion 123.

Meanwhile, although FIG. 4 illustrates the first flange 123a, the sealing region A2 may also be formed for the second flange 123b. A sealing length of the second flange 123b may have the same value as the sealing length LS of the first flange 123a but may also have a different value.

FIG. 5 is a cross-sectional view taken along a portion of line II-II′ of FIG. 2. FIG. 5 is a cross-sectional view illustrating a state in which the electrode lead 126 is coupled to the busbar 131.

The electrode lead 126 of each battery cell 120 may be coupled to the busbar 131. The electrode lead 126 may extend from the first flange 123a of the flange portion 123 in the first direction Y. The electrode lead 126 may pass through the coupling hole 133 of the busbar 131 in the first direction Y. The busbar 131 may include a plurality of coupling holes 133 to be coupled to the electrode leads 126 of the plurality of battery cells 120. The electrode lead 126 may be configured to pass through the through-portion 145 in the first direction Y and then be inserted into the coupling hole 133. Each electrode lead 126 may be electrically connected to the busbar 131 by laser welding or the like on the outside of the busbar 131 while being inserted into the coupling hole 133. The flange portion 123 of the battery cell 120 may include the sealing region A2 in which the folded outer sheet is fused.

The support plate 140 may be disposed between the plurality of battery cells 120 and the busbar 131. The support plate 140 may include the through-portion 145 through which the electrode lead 126 passes in the first direction Y.

The through-portion 145 may include a first region 141 disposed to be closer to the busbar 131 than the body portion 122 of the battery cell 120 and a second region 142 disposed to be closer to the body portion 122 of the battery cell 120 than the busbar 131. The first region 141 may face at least a portion of the sealing region A2, and the second region 142 may continuously connect to the first region 141 and extend from the first region 141 toward the body portion 122. The first region 141 may cover at least a portion of the sealing region A2 based on the first direction Y. The second region 142 may be defined as a portion extending from the first region 141 toward the body portion 122 and has a greater slope than the first region 141.

The second region 142 may be continuously connected to the first region 141. The first region 141 and the second region 142 may be configured to intersect each other at the boundary between the first region 141 and the second region 142. That is, the first region 141 and the second region 142 may be configured as continuous surfaces without a step. Based on the cross-section of FIG. 5, the first region 141 may have a straight shape, and the second region 142 may have a greater inclination angle θ than the first region 141. The second region 142 may have a straight shape, but it may also have a curved shape.

The first region 141 and the second region 142 may be formed integrally in the support plate 140. The first region 141 and the second region 142 may have an integral shape. The electrode lead 126 provided to each battery cell 120 may pass through the through-portion 145 in the first direction Y and then be coupled to the coupling hole 133.

The through-portion 145 of the support plate 140 may include a plurality of through-portions 145. The plurality of through-portions 145 may be disposed in the support plate 140 so that, in a state in which a plurality of battery cells 120 are stacked, a plurality of electrode leads 126 may be inserted in the first direction Y and coupled to the coupling holes 133 of the busbar 131. The plurality of through-portions 145 may be integrally formed on the support plate 140.

The electrode leads 126 may enter the through-portions 145 of the support plate 140 in the first direction Y to be coupled to the busbar 131. The second region 142 may be configured so that a space thereof becomes wider toward the body portion 122. The second region 142 may be configured to form a space becoming wider toward the body portion 122. The second region 142 may guide the electrode lead 126 to be easily inserted into the through-portion 145 of the support plate 140. Since the second region 142 has an inclined structure, the battery cell 120 may be easily assembled toward the support plate 140 and the busbar 131.

If gas occurs inside the battery cell 120 and the internal pressure of the battery cell 120 increases, the pressure of the gas may be transmitted from the body portion 122 toward the flange portion 123 and the gas may move to the flange portion 123. The flange portion 123 includes the sealing region A2 in which the outer sheet is fused and a region in which the outer sheet is not fused. That is, a portion of the flange portion 123 adjacent to the body portion 122 is not fused. Therefore, the non-fused portion of the flange portion 123 may easily swell or expand due to the pressure of the gas transmitted to the flange portion 123.

An empty space (gap) between the body portion 122 of the battery cell 120 and the support plate 140 may correspond to an expandable space SE in which the flange portion 123 may swell or expand. The expandable space SE may be defined as a space not covered by the support plate 140 in the entire length LF of the first flange 123a. If gas occurrence inside the battery cell 120 increases and the internal pressure of the battery cell 120 increases, the first flange 123a swells in the expandable space SE. Meanwhile, the second region 142 may function as an obstacle restricting the spreading or expansion of the first flange 123a. In addition, since the space corresponding to the first region 141 has a smaller size (gap) than the space corresponding to the second region 142, the first region 141 may further restrict the spreading or expansion of the first flange 123a than the second region 142.

The first region 141 may be configured to have a preset constant gap W. The gap W between the sealing region A2 and the first region 141 may have a small value as an assembly tolerance. For example, the sealing region A2 and the first region 141 may have a gap W of 2 mm or less therebetween. In addition, the sealing region A2 and the first region 141 may have a gap W of 1 mm or less therebetween. Since the gap W between the sealing region A2 and the first region 141 has a small value, the first region 141 may restrict the swelling or expansion of the sealing region A2.

Based on the first direction Y, the first region 141 may be configured to cover 60% or more of the sealing length LS, which is the length of the sealing region A2. The length by which the first region 141 covers the sealing region A2 may be defined as a first length L1. Since the gap W between the first region 141 and the sealing region A2 is narrow, when the first region 141 covers 60% or more of the sealing length LS (i.e., when the first length L1 is greater than or equal to 60% of the sealing length LS), the spreading or rupturing of the sealing region A2 may be restricted. That is, the first region 141 may provide a pressure resisting deformation of the sealing region A2. Accordingly, a timing at which venting occurs through the sealing region A2 of the first flange 123a may be delayed.

The first region 141 may also cover the entire length of the sealing region A2, and in this case, the first region 141 may cover 100% of the entire sealing length LS based on the first direction Y. The first region 141 may be configured to cover 70% or more and 100% or less of the sealing length LS based on the first direction Y. That is, the first length L1 may have a value of 70% or more and 100% or less of the sealing length LS. In addition, the first region 141 may cover 75% or more, 80% or more, or 90% or more of the sealing length LS. As the size of the first region 141 covering the sealing length LS increases (i.e., as the first length L1 increases), a venting timing caused by the spreading or rupturing of the sealing region A2 may be delayed. Accordingly, the venting at the first flange 123a may be delayed.

The second region 142 may be configured so that the space (gap) thereof becomes wider toward the body portion 122 to easily guide the electrode lead 126 to enter the through-portion 145. For example, the second region 142 may have an inclination angle θ of 5 degrees or more based on the axis Y1 of the first direction Y. In addition, the second region 142 may provide a pressure resisting deformation of the first flange 123a. The second region 142 may have an inclination angle θ of 40 degrees or less to function as an obstacle restricting the spreading or expansion of the first flange 123a. if the inclination angle θ of the second region 142 increases, it may be difficult to restrict the spreading or expansion of the first flange 123a. The second region 142 may also have an inclination angle θ of 30 degrees or less, 20 degrees or less, or 10 degrees or less. As the inclination angle θ of the second region 142 decreases, the spreading or expansion of the first flange 123a may be more restricted.

Meanwhile, the first region 141 may be configured to have a smaller inclination angle than the inclination angle θ of the second region 142 with respect to the axis Y1 of the first direction Y. For example, the inclination angle of the first region 141 may have an angle less than 5 degrees with respect to the first direction. The inclination angle of the first region 141 may also have an angle less than 3 degrees with respect to the first direction.

With respect to the first direction Y, a second length L2, which is the length of the second region 142, may have a value that is 0.5 times or more the sealing length LS. The second length L2 may be defined as a length from the boundary between the first region 141 and the second region 142 to an end portion of the second region 142 with respect to the first direction Y. If the second length L2 has a value smaller than 0.5 times the sealing length LS, the length of the second region 142 may become shorter, so that the first flange 123a cannot be sufficiently restricted from spreading or expanding by the second region 142.

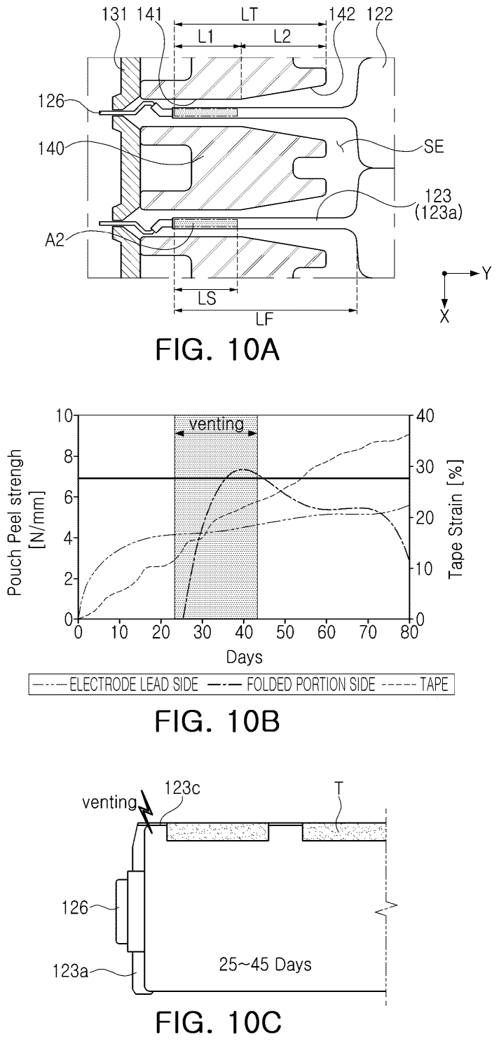

In addition, based on the first direction Y, the second length L2 may be configured to have a value equal to or less (smaller) than that of the sealing length LS. The second length L2 may be configured to have a value equal to or smaller than a first length L1, which is a length by which the first region covers the sealing region. If the second length L2 becomes greater than the sealing length LS and/or the second length L2 becomes greater than the first length L1, the size of the expandable space SE may be reduced. In this case, the gas expansion in the expandable space SE may not be sufficiently accommodated, and the volume in which the first flange 123a expands or inflates may be limited. If the expansion or inflating of the first flange 123a is not sufficiently allowed, the gas pressure inside the battery cell 120 may act on the second flange 123b. The first flange 123a may restrict the spreading or rupturing of the sealing region A2 by the first region 141, but the spreading or rupturing of the second flange 123b may be restricted only by the folded portion 123c and the tape T. Therefore, venting may occur first in the second flange 123b weaker than the first flange 123a. In the case in which the second length L2 becomes greater than the sealing length LS or the second length L2 becomes greater than the first length L1 as in the modified example illustrated in FIGS. 10A to 10C, the size of the expandable space SE may be reduced, and a venting timing through the second flange 123b may come earlier. Considering this, the second length L2 may be configured to have a value less than or equal to the sealing length LS.

In addition, with respect to the first direction Y, the sum LT of the first length L1, which is a length by which the first region 141 covers the sealing region A2, and the second length L2, which is a length of the second region 142, may be configured to have a value less than or equal to twice the sealing length LS. The sum of the first length L1 and the second length L2 may be defined as the total overlapping length of the first region 141 and the second region 142 covering the first flange 123a. Since the maximum value of the first length L1 corresponds to the sealing length LS, when the total overlapping length increases, the length by which the second region 142 covers the first flange 123a may increase. In this case, since the size of the expandable space SE is reduced, venting may occur through the second flange 123b and a venting timing may come earlier, similar to the case in which the second length L2 has a value greater than the sealing length LS.

Meanwhile, in the battery module according to an embodiment, by setting the size of the first region 141 and the second region 142 of the through-portion 145, a venting timing may be delayed and a location of the battery cell 120 in which venting occurs may be controlled.

For example, the battery module according to an embodiment may be configured to induce the location in which the venting occurs in the battery cell 120 to a location in which the electrode lead 126 is not disposed. That is, the venting may be controlled to occur earlier in the second flange 123b than in the first flange 123a of the battery cell 120. A venting gas may include a corrosive, flammable, or explosive gas. Therefore, when venting occurs in the second flange 123b, corrosion of the support plate 140 formed of an injection molded material may be reduced, stability of an electrical connection structure, such as the busbar 131, may be improved, and the possibility of fire may be reduced.

Meanwhile, although the conditions between the first length L1, the second length L2, and the sealing length LS have been described in various manners in the description of FIG. 5, the embodiment of the present disclosure does not have to satisfy all the conditions. For example, a case in which only some of the conditions among the conditions between the first length L1, the second length L2, and the sealing length LS are satisfied may also be included in the embodiment of the present disclosure.

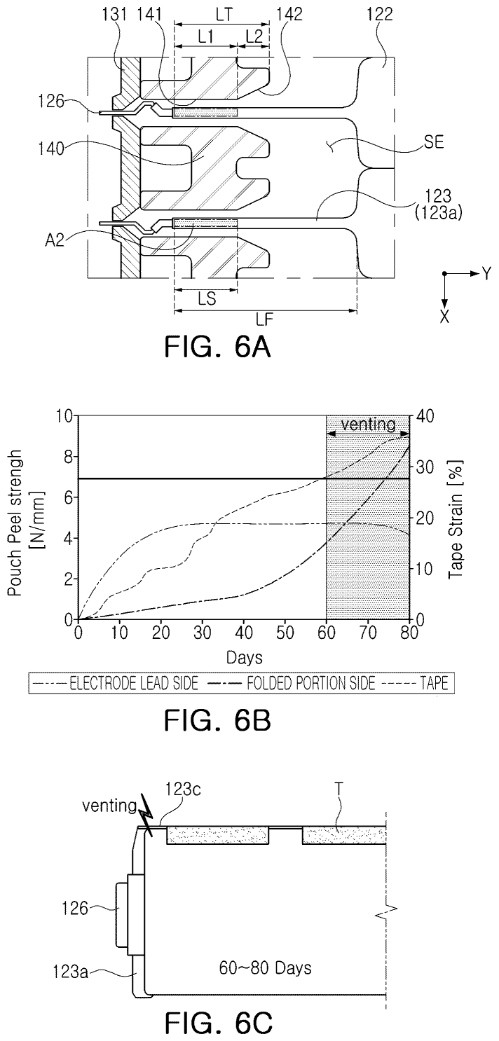

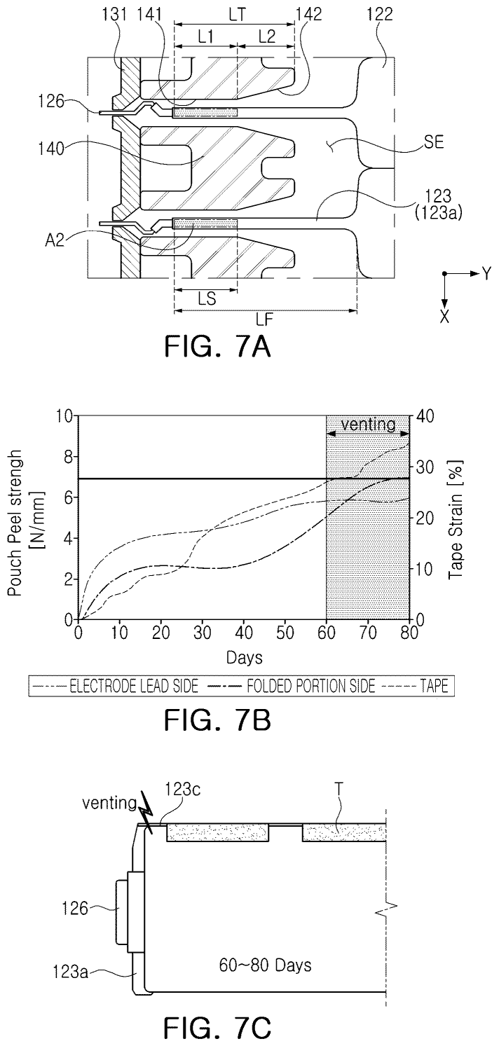

FIGS. 6A to 7C illustrate experimental results according to the first and second embodiments of the present disclosure, respectively, in which FIGS. 6A and 7A are cross-sectional views illustrating a state in which the flange portion 123 and the electrode lead 126 are disposed on the support plate 140, FIGS. 6B and 7B are graphs illustrating whether a battery cell 120 is vented over time, and FIGS. 6C and 7C are schematic diagrams indicating a portion in which venting occurs.

FIGS. 6A to 7C illustrate that a battery module was charged to 100% state of charge (SoC) and then stored at 60° C., and the capacity and internal resistance of the battery cell 120 were measured on a daily basis, and a venting timing of the battery cell 120 was measured. The internal resistance of the battery cell 120 was measured using the direct current internal resistance (DCIR) method.

The venting of the battery cell 120 may occur when a pouch peel strength acting on the first flange 123a and the second flange 123b has a value close to a first set value (7 N/mm) within a predetermined range (e.g., 5%) or when the strain acting on the tape T has a value close to a second set value (28%) within a predetermined range (e.g., 5%).

In the first embodiment illustrated in FIGS. 6A to 6C, the first length L1 in which the first region 141 covers the sealing region A2 is 5.0 mm, and the second length L2 formed by the second region 142 is 2.5 mm. The sum LT of the first length L1 and the second length L2 is 7.5 mm. The length of the sealing region A2, which is the sealing length LS, is 5.0 mm, and the total length LF of the first flange 123a is 14.5 mm.

In the case of the first embodiment, the peel strength acting on the first flange 123a on the electrode lead 126 side showed a value less than the first set value (7 N/mm) for 80 days, and the peel strength acting on the second flange 123b on the folded portion 123c side exceeded the first set value after approximately 70 days. The tape strain exceeded the second set value (28%) after approximately 60 days. The venting timing is an earlier timing among a timing when any one of the first flange 123a or the second flange 123b is close to the first set value and a timing when the tape strain is close to the second set value. Therefore, in the first embodiment, it was confirmed that the venting occurred in the second flange 123b in which the folded portion 123c was disposed for approximately 60 to 80 days.

In the second embodiment illustrated in FIGS. 7A to 7C, the first length L1 by which the first region 141 covers the sealing region A2 is 5.0 mm, and the second length L2 formed by the second region 142 is 4.5 mm. The sum LT of the first length L1 and the second length L2 is 9.5 mm. The sealing length LS, which is the length of the sealing region A2, is 5.0 mm, and the total length LF of the first flange 123a is 14.5 mm.

In the case of the second embodiment, the peel strength acting on the first flange 123a on the electrode lead 126 side showed a value less than the first set value (7 N/mm) for 80 days, and the peel strength acting on the second flange 123b on the folded portion 123c side exceeded the first set value after approximately 70 days. The tape strain exceeded the second set value (28%) after approximately 60 days. Therefore, in the second embodiment, it was confirmed that venting occurred in the second flange 123b in which the folded portion 123c was disposed between approximately 60 and 80 days.

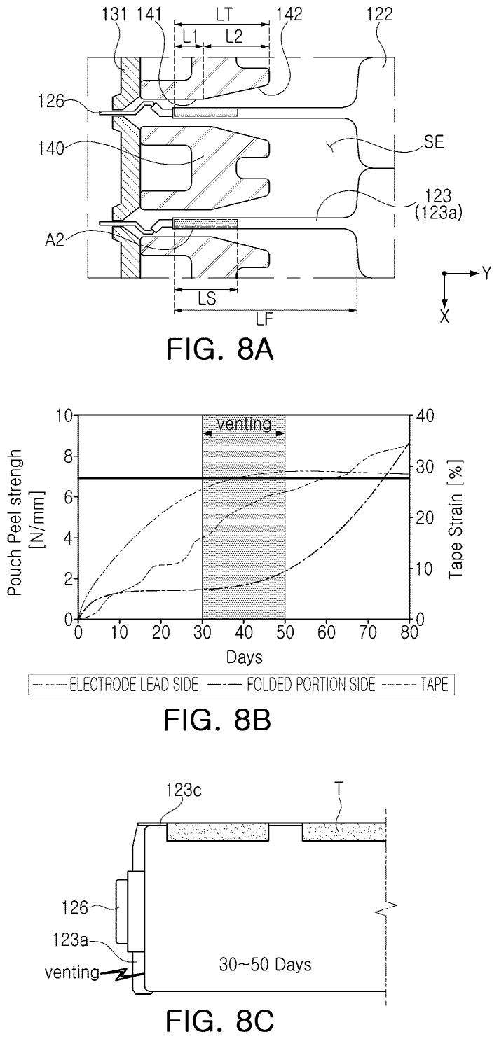

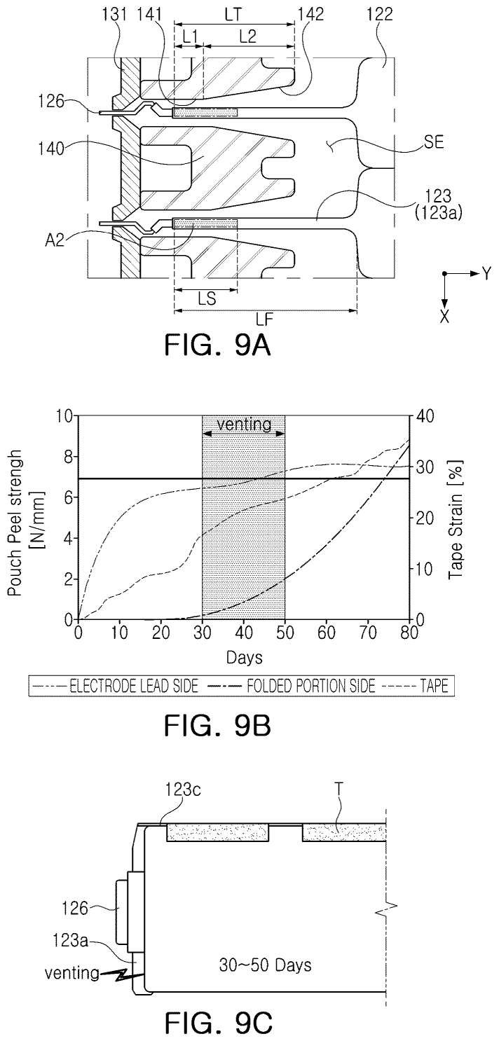

FIGS. 8A to 9C illustrate experimental results according to a first comparative example and a second comparative example, respectively. FIGS. 8A and 9A are cross-sectional views illustrating a state in which the flange portion 123 and the electrode lead 126 are disposed on the support plate 140, FIGS. 8B and 9B are graphs illustrating whether a battery cell 120 is vented over time, and FIGS. 8C and 9C are schematic diagrams indicating a portion in which venting occurs.

In the case of the first comparative example illustrated in FIGS. 8A to 8C and the second comparative example illustrated in FIGS. 9A to 9C, experiments were conducted in the same manner as in the first and second embodiments, but the first length L1 of the first region 141 and the second length L2 of the second region 142 were changed.

In the first comparative example illustrated in FIGS. 8A to 8C, the first length L1 of the first region 141 covering the sealing region A2 is 2.9 mm, and the second length L2 formed by the second region 142 is 4.6 mm. The sum LT of the first length L1 and the second length L2 is 7.5 mm. The sealing length LS, which is the length of the sealing region A2, is 5.0 mm, and the total length LF of the first flange 123a is 14.5 mm.

In the case of the first comparative example, the peel strength acting on the first flange 123a on the electrode lead 126 side exceeded the first set value (7 N/mm) after approximately 40 days, and the peel strength acting on the second flange 123b on the folded portion 123c side exceeded the first set value after approximately 70 days. The tape strain exceeded the second set value (28%) after approximately 60 days. The venting timing is an earlier timing among a timing when any one of the first flange 123a or the second flange 123b is close to the first set value and a timing when the tape strain is close to the second set value. Therefore, in the first comparative example, it was confirmed that venting occurred in the first flange 123a in which the electrode lead 126 was disposed between approximately 30 and 50 days.

In the second comparative example illustrated in FIGS. 9A to 9C, the first length L1 by which the first region 141 covers the sealing region A2 is 2.9 mm, and the second length L2 formed by the second region 142 is 6.6 mm. The sum LT of the first length L1 and the second length L2 is 9.5 mm. The sealing length LS, which is the length of the sealing region A2, is 5.0 mm, and the total length LF of the first flange 123a is 14.5 mm.

In the case of the second comparative example, the peel strength acting on the first flange 123a on the electrode lead 126 side exceeded the first set value (7 N/mm) after approximately 40 days, and the peel strength acting on the second flange 123b on the folded portion 123c side exceeded the first set value after approximately 70 days. The tape strain exceeded the second set value (28%) after approximately 60 days. Therefore, in the second comparative example, it was confirmed that venting occurred in the first flange 123a in which the electrode lead 126 was disposed between approximately 30 and 50 days.

Comparing FIGS. 6A to 9C, in the first embodiment and the second embodiment, since the first length L1 by which the first region 141 covers the sealing region A2 is 60% or more of the sealing length LS, the venting timing may be delayed, compared to the first comparative example and the second comparative example. In the first embodiment and the second embodiment, venting occurred at approximately 60 to 80 days, while in the first comparative example and the second comparative example, venting occurred at approximately 30 to 50 days. Therefore, the first embodiment and the second embodiment were able to delay the venting timing by approximately 1.2 to 2 times compared to the first comparative example and the second comparative example. In addition, a point in which the venting occurred in the battery cell 120 was able to be induced to the second flange 123b in which the folded portion 123c is located.

In the case of the first embodiment and the second embodiment, since the first region 141 is configured to cover 70% or more and 100% or less of the sealing length LS or since the second length L2 has a value of 0.5 times or more of the sealing length LS, the venting timing may be delayed, compared to the first comparative example and the second comparative example.

In addition, in the case of the first embodiment and the second embodiment, since the second length L2 has a value less than or equal to the sealing length LS, since the second length L2 has a value less than or equal to the first length L1, or since the sum LT of the first length L1 and the second length L2 has a value less than or equal to twice the sealing length LS, the venting timing may be delayed, compared to the first comparative example and the second comparative example.

Meanwhile, FIGS. 10A to 10C illustrate experimental results according to modified examples, in which FIG. 10A is a cross-sectional view illustrating a state in which the flange portion 123 and the electrode lead 126 are disposed on the support plate 140, FIG. 10B is a graph illustrating whether the battery cell 120 is vented over time, and FIG. 10C is a schematic diagram showing a portion in which venting occurs.

Meanwhile, in the modified example illustrated in FIGS. 10A to 10C, the first length L1 by which the first region 141 covers the sealing region A2 is 5.0 mm, and the second length L2 formed by the second region 142 is 7.0 mm. The sum LT of the first length L1 and the second length L2 is 12.0 mm. The length of the sealing region A2, the sealing length LS, is 5.0 mm, and the total length LF of the first flange 123a is 14.5 mm.

In the modified example illustrated in FIGS. 10A to 10C, the peel strength acting on the first flange 123a on the electrode lead 126 side showed a value less than the first set value (7 N/mm) for 80 days, and the peel strength acting on the second flange 123b on the folded portion 123c side exceeded the first set value after approximately 30 days. The tape strain exceeded the second set value (28%) after approximately 50 days. The venting timing is an earlier time among a timing when any one of the first flange 123a or the second flange 123b is close to the first set value and a timing when the tape strain is close to the second set value. Therefore, in the case of the modified example, it was confirmed that venting occurred in the second flange 123b in which the folded portion 123c was disposed between approximately 25 and 45 days.

As in the modified example illustrated in FIGS. 10A to 10C, when the second length L2 by which the second region 142 covers the first flange 123a becomes excessively large, the size of the expandable space SE of the first flange 123a may decrease. In this case, it may be confirmed that the first flange 123a does not expand sufficiently, so that a high gas pressure acts on the second flange 123b and the venting timing of the second flange 123b comes earlier.

Therefore, in order to secure the expandable space SE of the first flange 123a, the second region 142 by which the second length L2 covers the first flange 123a may be reduced to a certain value or less. For example, the second length L2 may be configured to have a value less than or equal to the sealing length LS, or the second length L2 may have a value less than or equal to the first length L1, or the sum LT of the first length L1 and the second length L2 may have a value less than or equal to twice the sealing length LS.

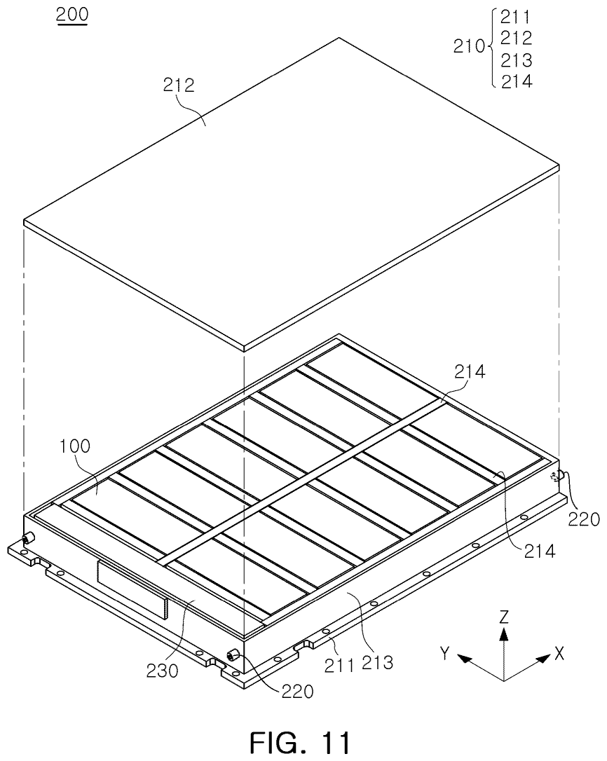

FIG. 11 is an exploded perspective view of a battery pack 200 according to an embodiment.

Referring to FIG. 11, the battery pack 200 may include at least one battery module 100 and a pack frame 210 accommodating at least one battery module 100. The description of the battery module 100 described above with reference to FIGS. 1 to 7C may be applied to the battery module 100 of FIG. 11.

The pack frame 210 may accommodate a component of the battery pack 200 (e.g., the battery module 100). The pack frame 210 may include a bottom member 211 supporting the battery module 100, a pack cover 212 covering the battery module 100, and a sidewall 213 connecting the bottom member 211 and the pack cover 212.

The pack frame 210 may include a partition 214 crossing a space in which the battery module 100 is installed. For example, an accommodation space of the pack frame 210 may be divided into a plurality of spaces by the partition 214. The partition 214 may be installed across the accommodation space to reinforce the rigidity of the pack frame 210.

In an embodiment, at least a portion of the pack frame 210 may include a venting member 220 to guide a path of gas and/or flames occurring in the battery module 100. For example, the venting member 220 may be disposed on the sidewall 213, but the installation location and number thereof are not limited thereto. The venting member 220 may include a venting hole disposed in at least a portion of the pack frame 210. The venting member 220 may include a venting valve opening the venting hole when gas pressure inside the pack frame 210 increases.

The battery pack 200 may include a battery controller 230 controlling the battery module 100. The battery controller 230 may be disposed within the pack frame 210. The battery controller 230 may include a battery management system (BMS). The configuration of the battery controller 230 is known in various forms, so a detailed description thereof will be omitted. In an embodiment, the battery controller 230 may be referred to as a processor.

According to an embodiment of the present disclosure, the venting timing of a battery cell may be delayed.

According to an embodiment of the present disclosure, a location in which venting occurs in a battery cell may be controlled. For example, the location in which venting occurs in a battery cell may be induced to a location in which an electrode lead is not disposed.

According to an embodiment of the present disclosure, a thermal runaway phenomenon of the battery module or the battery pack may be delayed or restricted.

Only specific examples of implementations of certain embodiments are described. Variations, improvements and enhancements of the disclosed embodiments and other embodiments may be made based on the disclosure of this patent document. For example, it may be implemented by deleting some components in the above-described embodiments, and each of the embodiments and modified examples may be implemented in combination with each other.

What is claimed is:

1. A battery module comprising:
a cell assembly including a plurality of battery cells, each battery cell including a body portion accommodating an electrode assembly, a flange portion extending from at least a portion of a periphery of the body portion, and an electrode lead electrically connected to the electrode assembly and exposed in a first direction to the outside of the flange portion;
a busbar coupled to the electrode lead of each battery cell; and
a support plate disposed between the battery cell and the busbar and including a through-hole through which the electrode lead passes in the first direction,
wherein the flange portion includes a sealing region in which an outer sheet that is folded is fused,
the through-portion includes a first region disposed closer to the busbar than the body portion and a second region disposed closer to the body portion than the busbar and continuously connected to the first region, and
the first region is configured to cover 60% or more of a sealing length, which is a length of the sealing region, based on the first direction.

2. The battery module of claim 1, wherein the first region and the second region are configured to intersect each other at a boundary between the first region and the second region.

3. The battery module of claim 1, wherein the first region is configured to have a preset constant interval, and the second region is configured to form a space becoming wider toward the body portion.

4. The battery module of claim 1, wherein a gap between the sealing region and the first region is 2 mm or less.

5. The battery module of claim 1, wherein the first region is configured to have a smaller inclination angle than an inclination angel of the second region with respect to the first direction.

6. The battery module of claim 1, wherein the first region is configured to have an inclination angle less than 3 degrees with respect to the first direction, and the second region is configured to have an inclination angle of 5 degrees or more with respect to the first direction.

7. The battery module of claim 1, wherein, based on the first direction, the first region is configured to cover 70% or more and 100% or less of the sealing length.

8. The battery module of claim 1, wherein, based on the first direction, a second length, which is a length of the second region, is 0.5 times or more of the sealing length.

9. The battery module of claim 8, wherein the second length is configured to have a value equal to or less than that of the sealing length.

10. The battery module of claim 1, wherein, based on the first direction, a second length, which is a length of the second region, is configured to have a value equal to or smaller than a first length, which is a length by which the first region covers the sealing region.

11. The battery module of claim 1, wherein, based on the first direction, the sum of a first length, which is a length by which the first region covers the sealing region, and a second length, which is a length of the second region, is configured to have a value less than or equal to twice the sealing length.

12. The battery module of claim 1, wherein the busbar includes a coupling hole coupled to the electrode lead of each battery cell, and the electrode lead is configured to pass through the through-portion in the first direction and then be inserted into the coupling hole.

13. The battery module of claim 12, wherein the first region and the second region are formed integrally in the support plate.

14. The battery module of claim 1, wherein the through-portion of the support plate includes a plurality of through-portions so that a plurality of electrode leads are inserted in the first direction, while the plurality of battery cells are stacked.

15. The battery module of claim 14, wherein the plurality of through-portions are integrally formed in the support plate.

16. The battery module of claim 1, wherein the flange portion is disposed on at least three sides of a perimeter of the body portion, and the flange portion includes a first flange in which the electrode lead is disposed and a second flange in which the electrode lead is not disposed.

17. The battery module of claim 16, further comprising:
a module housing accommodating the cell assembly and including a housing cover covering a top surface of the cell assembly,
wherein the housing cover faces the second flange.

18. The battery module of claim 17, wherein the second flange includes a folded portion folded in a length direction of the battery cell and a tape covering the folded portion to restrict the folded portion from unfolding.

19. A battery module comprising:
a cell assembly including a plurality of battery cell each including a body portion accommodating an electrode assembly, a flange portion extending from at least a portion of a periphery of the body portion and including a sealing region, and an electrode lead exposed to the outside of the flange portion in a first direction;
a busbar including a plurality of coupling holes coupled to the electrode leads of the plurality of battery cells; and
a support plate disposed between the plurality of battery cells and the busbar, and including a plurality of through-portions through which the electrode leads of the plurality of battery cells pass in the first direction,
wherein each through-portion includes a first region facing at least a portion of the sealing region and a second region continuously connected to the first region and extending toward the body portion, and the first region is configured to cover 60% or more of a sealing length, which is a length of the sealing region, based on the first direction.

20. A battery pack comprising:
a plurality of battery modules according to claim 1, and
a pack frame accommodating the plurality of battery modules.
